(19) United States
(12) Patent Application Publication
(10) Pub. No.: US 2026/0051662 A1
(43) Pub. Date: Feb. 19, 2026

(54) RADIO WAVE LENS

(71) Applicant: NTT, Inc., Tokyo (JP)

(72) Inventors: Daisuke Kitayama, Tokyo (JP); Adam Pander, Tokyo (JP); Hiroyuki Takahashi, Tokyo (JP)

(21) Appl. No.: 18/869,643

(22) PCT Filed: May 31, 2022
(86) PCT No.: PCT/JP2022/022089

§ 371 Date: Oct. 22, 2025

(51) Int. Cl. H01Q 15/02

(52) U.S. Cl. CPC H01Q 15/02

(57) ABSTRACT

In a radio wave lens, unit cells are two-dimensionally disposed on a plane of a substrate intersecting an incident radio wave. In the unit cells, a conductor portion bent in a crank shape in a plane of the substrate is formed, or a conductor-removed region bent in a crank shape in the plane of the substrate is formed in a conductor layer on the substrate. The unit cells in which the bending directions of the conductor portions or the bending directions of the conductor-removed regions are different from each other are two-dimensionally disposed according to a desired phase distribution of the radio wave transmitted through the unit cells.

### CROSS-REFERENCE TO RELATED APPLICATIONS

This application is a national phase entry of PCT Application No. PCT/JP2022/022089, filed on May 31, 2022, which application is hereby incorporated herein by reference.

### TECHNICAL FIELD

The present invention relates to a radio wave lens that controls a transmission phase distribution of a radio wave.

### BACKGROUND

Radio waves in the millimeter wave band and the terahertz wave band used in the fifth generation mobile communication system (5G) and the sixth generation mobile communication system (6G) have high straight-line propagation properties, and thus there is a problem that communication quality is significantly deteriorated in a non-line-of-sight area from a base station. This deterioration in the communication quality is a problem when an outdoor base station makes an indoor area as communication area through the window of a building.

In recent years, a technology of guiding a radio wave to an indoor relay device or the like by attaching a film or the like having a lens function to a window glass with a metasurface technology capable of designing scattering characteristics of an incoming wave (refer to, for example, Non Patent Literature 1) has attracted attention. In Non Patent Literature 1, a film on which a metal metasurface pattern is formed is attached to a window glass to form the distribution of radio wave transmission and reflection on the window glass surface, and thus a desired planar transmission intensity distribution (binary distribution of 1 (transmission) and 0 (reflection)) and a radio wave lens function are realized.

However, in the case of forming the distribution of radio wave transmission and reflection as in Non Patent Literature 1, there is a problem that only a part of radio waves reaching the window can be used for indoor propagation.

### CITATION LIST

### Non Patent Literature

Non Patent Literature 1: Daisuke Kitayama, et al., “Transparent dynamic metasurface for a visually unaffected reconfigurable intelligent surface: controlling transmission/reflection and making a window into an RF lens”, Optics Express, vol. 29, No. 18, pp. 29292-29307, 2021

### SUMMARY

### Technical Problem

Embodiments of the present invention have been made to solve the above-described problems, and an object of embodiments of the present invention is to provide a radio wave lens capable of utilizing almost all incoming radio waves as transmitted waves.

### Solution to Problem

According to an aspect of embodiments of the present invention, there is provided a radio wave lens including a first unit cell and a second unit cell that are two-dimensionally disposed on a plane of a substrate intersecting an incident radio wave, in which in each of the first unit cell and the second unit cell, a conductor portion bent in a crank shape in the plane of the substrate is formed or a conductor-removed region bent in the crank shape in the plane of the substrate is formed in a conductor layer on the substrate, bending directions of the conductor portions or the bending directions of the conductor-removed regions are different from each other, and the first unit cell and the second unit cell are two-dimensionally disposed according to a desired phase distribution of the radio wave transmitting through the first unit cell and the second unit cell.

### Advantageous Effects

According to embodiments of the present invention, in the first unit cell and the second unit cell, the conductor portion bent in the crank shape in the plane of the substrate is formed or the conductor-removed region bent in the crank shape in the plane of the substrate is formed, the first unit cell and the second unit cell are two-dimensionally disposed according to the desired phase distribution of the transmitted radio wave such that the bending directions of the conductor portions or the bending directions of the conductor-removed regions are different from each other. Therefore, it is possible to utilize almost all of the incoming radio waves as the transmitted waves and to improve the efficiency of the radio wave lens.

### BRIEF DESCRIPTION OF THE DRAWINGS

FIG. 1 is a diagram illustrating a difference between a technology of the related art and the present invention.

FIGS. 2A and 2B are plan views illustrating a structure of a unit cell of a radio wave lens according to a first embodiment of the present invention.

FIG. 3 is a diagram illustrating a transmitted/scattered wave intensity of a unit cell according to the first embodiment of the present invention.

FIG. 4 is a diagram illustrating the transmitted/scattered wave phase of a unit cell according to the first embodiment of the present invention.

FIG. 5 is a plan view illustrating a structure of a radio wave lens according to the first embodiment of the present invention.

FIG. 6 is a diagram illustrating an arrangement determination method of a unit cell according to a second embodiment of the present invention.

FIGS. 7A and 7B are plan views illustrating a structure of a unit cell according to first, second, and third embodiments of the present invention.

FIG. 8 is a diagram illustrating a transmitted/scattered wave intensity of a unit cell according to the first, second, and third embodiments of the present invention.

FIGS. 9A and 9B are plan views illustrating a structure of a unit cell according to the third embodiment of the present invention.

FIG. 10 is a diagram illustrating a transmitted/scattered wave intensity of a unit cell according to the third embodiment of the present invention.

FIG. 11 is a diagram illustrating a transmitted/scattered wave phase of a unit cell according to the third embodiment of the present invention.

FIG. 12 is a plan view illustrating a structure of a radio wave lens according to the third embodiment of the present invention.

FIGS. 13A and 13B are perspective views illustrating a structure of a unit cell according to the third embodiment of the present invention.

FIG. 14 is a diagram illustrating a result obtained by performing electromagnetic field analysis of a scattered wave phase difference for the unit cells of FIGS. 13A and 13B.

FIG. 15 is an exploded perspective view illustrating a structure of a unit cell according to a fourth embodiment of the present invention.

FIGS. 16A to 16C are plan views illustrating a structure of a polarizing layer and a structure of a conductor layer in a unit cell according to the fourth embodiment of the present invention.

FIG. 17 is a diagram illustrating a transmitted/scattered wave intensity of a unit cell according to the third and fourth embodiments of the present invention.

FIGS. 18A and 18B are perspective views illustrating a structure of a unit cell according to the third and fourth embodiments of the present invention.

FIG. 19 is a diagram illustrating a result obtained by performing electromagnetic field analysis of a transmitted/scattered wave intensity for the unit cells of FIGS. 18A and 18B.

FIGS. 20A and 20B are plan views illustrating a structure of a unit cell according to a fifth embodiment of the present invention.

FIGS. 21A and 21B are plan views illustrating another structure of a unit cell according to the fifth embodiment of the present invention.

FIGS. 22A and 22B are plan views illustrating a structure of a unit cell according to a sixth embodiment of the present invention.

FIGS. 23A and 23B are plan views illustrating another structure of a unit cell according to the sixth embodiment of the present invention.

FIGS. 24A and 24B are plan views illustrating a structure of a unit cell according to a seventh embodiment of the present invention.

FIGS. 25A and 25B are plan views illustrating another structure of a unit cell according to the seventh embodiment of the present invention.

### DETAILED DESCRIPTION OF ILLUSTRATIVE EMBODIMENTS

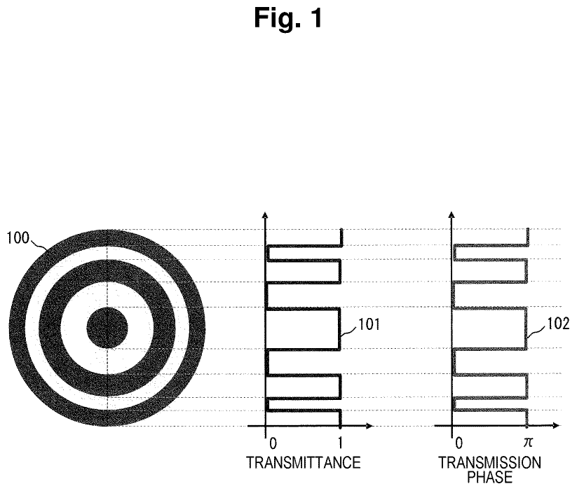

FIG. 1 is a diagram illustrating a difference between a technology disclosed in Non Patent Literature 1 and embodiments of the present invention. In the related art, a binary transmission intensity distribution 101 of 1 (transmission) and 0 (reflection) is formed with a metal metasurface pattern 100. On the other hand, in embodiments of the present invention, a binary transmission phase distribution 102 of 0 and π [rad] is formed. As described above, in embodiments of the present invention, not the transmission intensity but the transmission phase distribution of the radio wave is formed by a single-layer metasurface pattern, and almost all the radio waves reaching the metasurface are utilized as the transmitted waves.

### First Embodiment

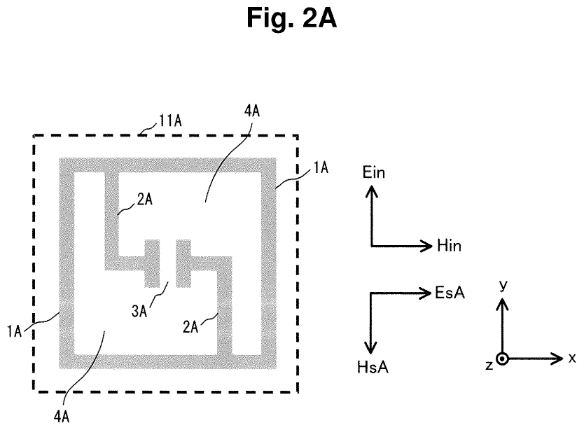

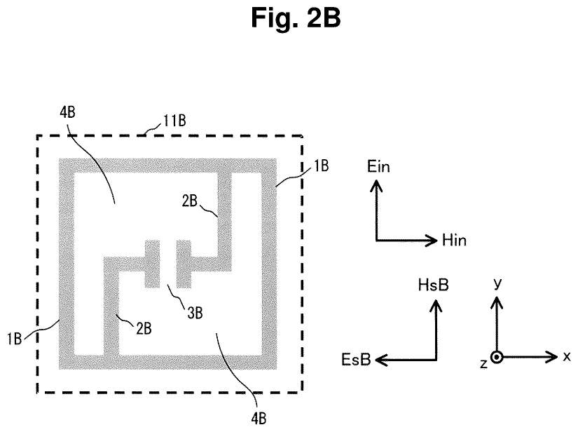

Hereinafter, embodiments of the present invention will be described with reference to the drawings. FIGS. 2A and 2B are plan views illustrating a structure of a unit cell of a radio wave lens according to a first embodiment of the present invention. A unit cell 11A includes an annular metal conductor portion 1A formed on a substrate, a metal conductor portion 2A formed on the substrate so as to connect two points of the conductor portion 1A and equally divide a region in the conductor portion 1A without a conductor pattern into two, and a gap 3A dividing the conductor portion 2A so as to connect two regions 4A equally divided by the conductor portion 2A. The conductor portion 2A has two bent portions bent at 90 degrees, and the gap 3A is disposed between two bent portions.

A unit cell 11B includes an annular metal conductor portion 1B formed on a substrate, a metal conductor portion 2B formed on the substrate so as to connect two points of the conductor portion 1B and equally divide a region in the conductor portion 1B without the conductor pattern into two, and a gap 3B dividing the conductor portion 2B so as to connect two regions 4B equally divided by the conductor portion 2B. The conductor portion 2B has two bent portions bent at 90 degrees, and the gap 3B is disposed between two bent portions.

In the present invention, the radio wave is incident from a direction perpendicular to a plane (FIGS. 2A and 2B) including the conductor portions 1A and 2A of the unit cell 11A, the gap 3A, the conductor portions 1B and 2B of the unit cell 11B, and the gap 3B. In FIGS. 2A and 2B, x, y, and z represent coordinate axes, Hin represents a direction of a magnetic field component of the incident radio wave (incoming wave), Ein represents a direction of an electric field component of the incoming wave, HsA represents a direction of the magnetic field component of the scattered wave radiated from the gap 3A of the unit cell 11A, EsA represents a direction of the electric field component of the scattered wave radiated from the gap 3A, HsB represents a direction of the magnetic field component of the scattered wave radiated from the gap 3B of the unit cell 11B, and EsB represents a direction of the electric field component of the scattered wave radiated from the gap 3B.

In the present embodiment, the conductor portion 2A is bent in a crank shape in a plane including the conductor portions 1A and 2A of the unit cell 11A and the gap 3A, and a direction in which the gap 3A crosses the conductor portion 2A (vertical direction in FIGS. 2A and 2B) and a direction of an electric field component Ein of the incoming wave are parallel, and thus the scattered wave radiated from the gap 3A includes an electric field component EsA orthogonal to the direction of the electric field component Ein of the incoming wave. Furthermore, the conductor portion 2B is bent in a crank shape in a plane including the conductor portions 1B and 2B of the unit cell 11B and the gap 3B, and a direction in which the gap 3B crosses the conductor portion 2B and the direction of the electric field component Ein of the incoming wave are parallel, and thus the scattered wave radiated from the gap 3B includes an electric field component EsB orthogonal to the direction of the electric field component Ein of the incoming wave. In the present embodiment, the scattered wave with polarization rotated by 90 degrees with respect to the incoming wave is utilized as the transmitted wave.

Furthermore, in the unit cells 11A and 11B, the conductor portions 2A and 2B are bent in a crank shape, but the bending directions of the conductor portion 2A and the conductor portion 2B are opposite to each other. That is, the unit cell 11A and the unit cell 11B are in mirror reflection symmetry.

The intensity of the scattered wave with polarization rotated by 90 degrees with respect to the incoming wave is maximized in the vicinity of the resonance frequencies of the unit cells 11A and 11B. The resonance frequency of the unit cell 11A is determined by a capacitive component or inductive component derived from the conductor portions 1A and 2A and the gap 3A. Similarly, the resonance frequency of the unit cell 11B is determined by a capacitive component or inductive component derived from the conductor portions 1B and 2B and the gap 3B. The resonance frequencies of the unit cells 11A and 11B are designed depending on the frequency desired to be used.

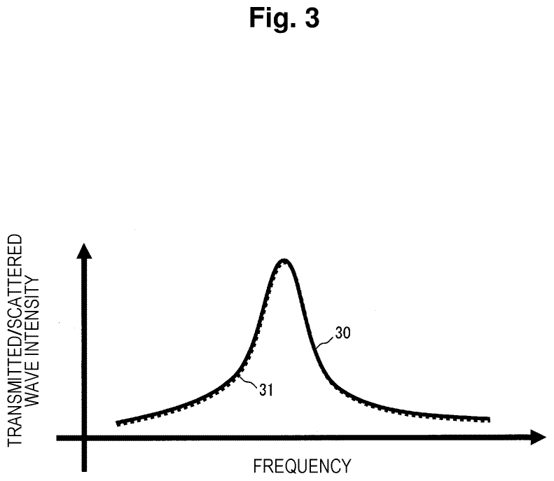

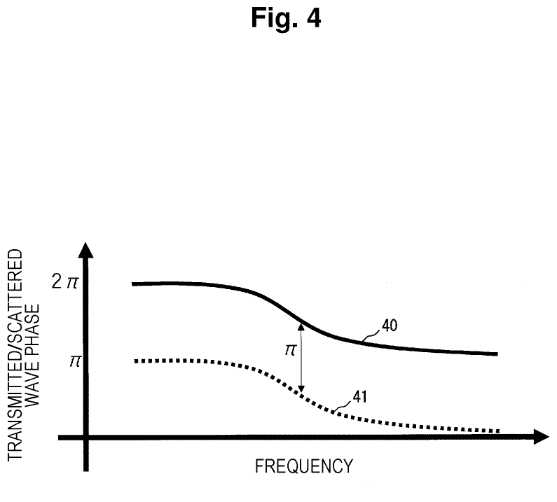

The phase of the scattered wave with respect to the phase of the incoming wave has a value different by π [rad] between the unit cell 11A and the unit cell 11B in which the bending directions of the conductor portion 2A and the conductor portion 2B are opposite. FIG. 3 is a diagram illustrating the transmitted/scattered wave intensities of the unit cells 11A and 11B, and FIG. 4 is a diagram illustrating the transmitted/scattered wave phases of the unit cells 11A and 11B. Reference numerals 30 and 31 in FIG. 3 indicate the scattered wave intensities of the unit cells 11A and 11B, respectively. Reference numerals 40 and 41 in FIG. 4 indicate the scattered wave phases of the unit cells 11A and 11B, respectively.

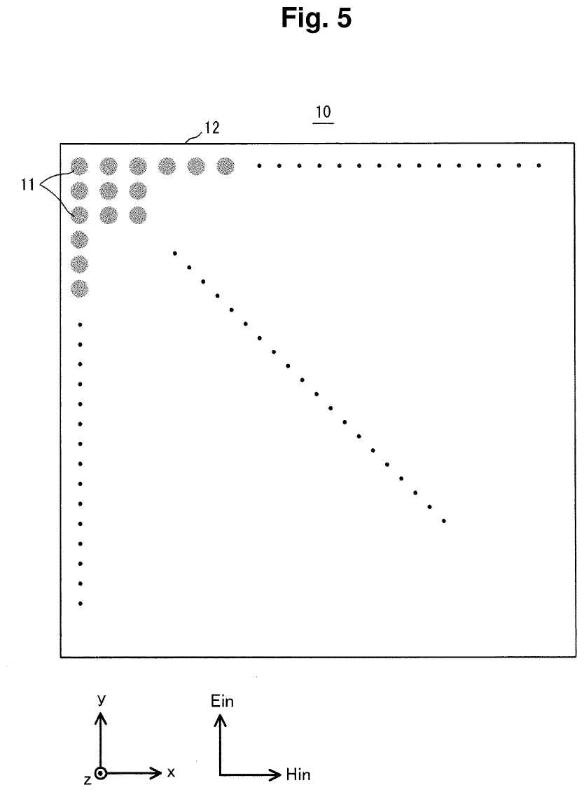

In the present embodiment, as illustrated in FIG. 5, the unit cells 11A and 11B are two-dimensionally disposed on a substrate 12 made of a dielectric such as glass according to a desired binary phase distribution of 0 and π [rad], and thus a phase distribution radio wave lens 10 can be realized with only one metal metasurface pattern layer. Reference numeral 11 in FIG. 5 indicates the unit cell 11A or the unit cell 11B. In the present embodiment, almost all the radio waves reaching the metasurface can be utilized as transmitted waves, and the efficiency of the radio wave lens 10 can be improved as compared with the related art.

### Second Embodiment

Next, a second embodiment of the present invention will be described. Also in the present embodiment, since the structure of the unit cell of the radio wave lens is similar to that in the first embodiment, the description will be made by using reference numerals in FIGS. 2A and 2B. In the present embodiment, when the radio wave is guided from a wave source of the incoming wave to a desired reception point via the radio wave lens, the unit cells 11A and 11B are disposed so as to correct a phase difference Gₙ caused by an optical path length difference between the unit cells.

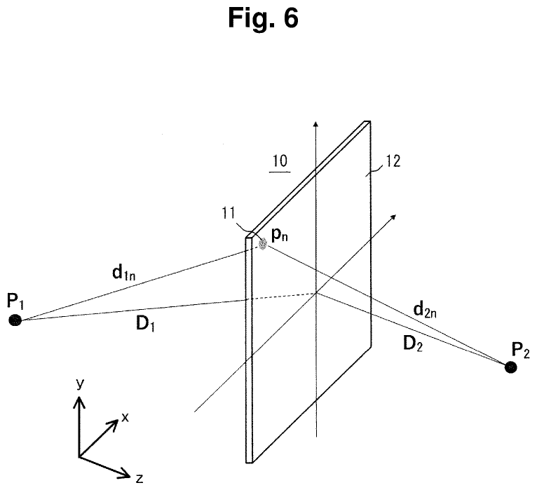

FIG. 6 is a diagram illustrating an arrangement determination method of the unit cells 11A and 11B according to the present embodiment. The total number of the unit cells 11A and 11B constituting the radio wave lens 10 is denoted by N, the wave source of the incoming wave incident on the radio wave lens 10 is denoted by P₁, the reception point at which energy is desired to be guided via the radio wave lens 10 is denoted by P₂, the position of the nth unit cell 11 (11A or 11B) is denoted by pₙ (n is an integer of 1 to N), the distance from P₁ to an arbitrary reference point of the substrate 12 (the center point of the substrate 12 in the example of FIG. 4) is denoted by D₁, the distance from P₂ to the reference point is denoted by D₂, the distance from P₁ to pₙ is denoted by din, and the distance from P₂ to pₙ is denoted by den. The phase difference Gₙ of the radio wave caused by the optical path length difference between the unit cells at the reception point P₂ is represented Equation below.

$${G}_{n} = 2 π ( ( {d}_{1 n} - {D}_{1} ) + ( {d}_{2 n} - {D}_{2} ) ) / λ \qquad ( 1 )$$

λ is the wavelength of the incoming wave. By correcting the phase difference Gₙ of the radio wave between the unit cells and disposing the unit cells such that the phases of the radio waves reaching the reception point P₂ from each of the unit cells coincide with each other, it is possible to determine the unit cell arrangement for guiding the scattered wave to the reception point P₂.

For example, the unit cell 11A is only required to be disposed at a position on the substrate 12 where a remainder obtained by dividing the phase difference Gₙ by 2π is in the range of zero to π, and the unit cell 11B is only required to be disposed at a position where the remainder is in the range of π to 2π. Note that a similar function can be realized even when the arrangement of the unit cell 11A and the arrangement of the unit cell 11B are switched.

Furthermore, in a case where the distance D₁ is calculated to be sufficiently longer than the size of the radio wave lens 10, it is possible to determine the unit cell arrangement assuming a plane wave coming from the direction of a wave source P₁. Furthermore, in a case where the distance D₂ is calculated to be sufficiently longer than the size of the radio wave lens 10, a function of deflecting the transmitted wave in the direction of the reception point P₂ can be realized.

### Third Embodiment

When the polarization of the incoming wave is rotated by 90 degrees with respect to the first embodiment by using the unit cell in which the presence or absence of the conductor pattern of the unit cell of the first embodiment is inverted, the intensity of the transmitted wave with polarization rotated by 90 degrees with respect to the incoming wave is maximized in the vicinity of the resonance frequency of the unit cell, and the scattered wave is radiated in the transmission direction even in a region where the frequency is higher than the resonance frequency.

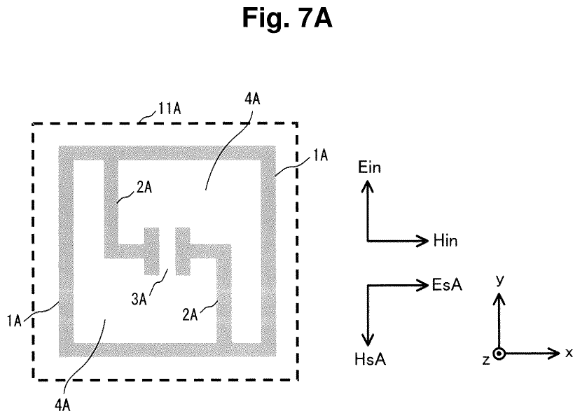

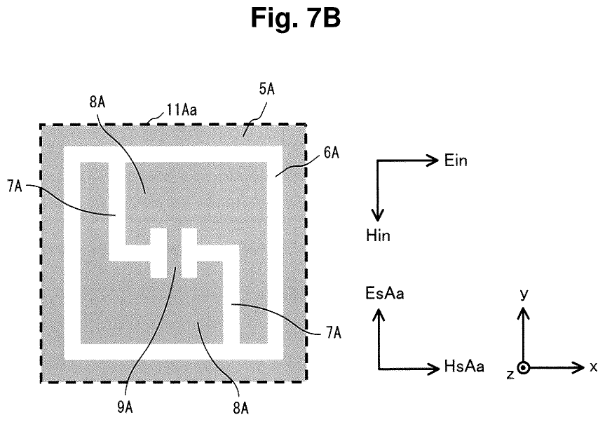

FIGS. 7A and 7B are plan views illustrating the structure of the unit cell according to the first embodiment and the present embodiment. A unit cell 11Aa includes a metal conductor layer 5A formed on the substrate and having a rectangular shape in plan view. In the conductor layer 5A, an annular conductor-removed region 6A, a conductor-removed region 7A formed so as to connect two points of the conductor-removed region 6A and equally divide the conductor pattern in the conductor-removed region 6A into two, two conductor patterns 8A equally divided by the conductor-removed region 7A, and a conductor remaining portion 9A dividing the conductor-removed region 7A so as to connect two conductor patterns 8A are formed. In the present embodiment, the conductor-removed region 7A is bent in a crank shape in the plane of the conductor layer 5A. The conductor-removed region 7A has two bent portions bent at 90 degrees, but the conductor remaining portion 9A is disposed between two bent portions. In this way, the unit cell 11Aa has a shape in which the presence or absence of the conductor pattern of the unit cell 11A is inverted.

Similarly to the first and second embodiments, also in the present embodiment, the incoming wave is incident from a direction perpendicular to a surface (FIGS. 7A and 7B) including the conductor layer 5A of the unit cell 11Aa. In FIGS. 7A and 7B, HsAa represents the direction of the magnetic field component of the scattered wave radiated from the unit cell 11Aa, and EsAa represents the direction of the electric field component of the scattered wave radiated from the unit cell 11Aa.

In the first and second embodiments, the direction in which the gaps 3A and 3B cross the conductor portions 2A and 2B (vertical direction in FIGS. 2A, 2B, 7A, and 7B) is parallel to the direction of the electric field component Ein of the incoming wave.

On the other hand, in the present embodiment, the direction in which the conductor remaining portion 9A crosses the conductor-removed region 7A (vertical direction in FIGS. 7A and 7B) is orthogonal to the direction of the electric field component Ein of the incoming wave.

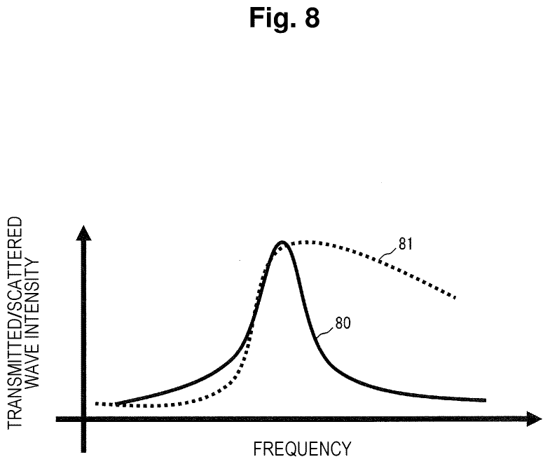

FIG. 8 illustrates the transmitted/scattered wave intensity of the unit cells 11A of the first and second embodiments and the transmitted/scattered wave intensity of the unit cell 11Aa of the present embodiment. Reference numerals 80 and 81 indicate the scattered wave intensities of the unit cells 11A and 11Aa, respectively. As can be seen from FIG. 8, in the vicinity of the resonance frequency of the unit cell 11Aa, the intensity of the transmitted wave with polarization rotated by 90 degrees with respect to the incoming wave is maximized, and the scattered wave is radiated in the transmission direction even in a region where the frequency is higher than the resonance frequency.

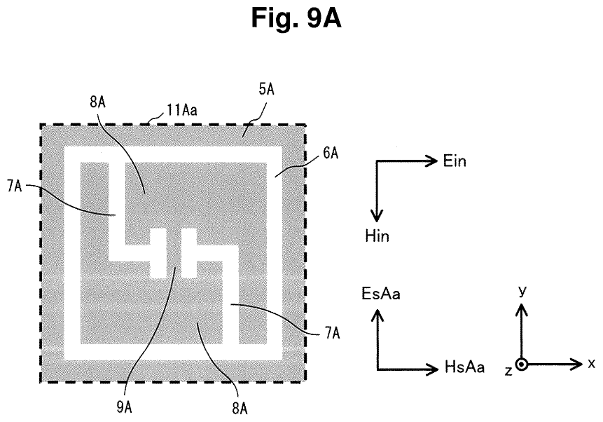

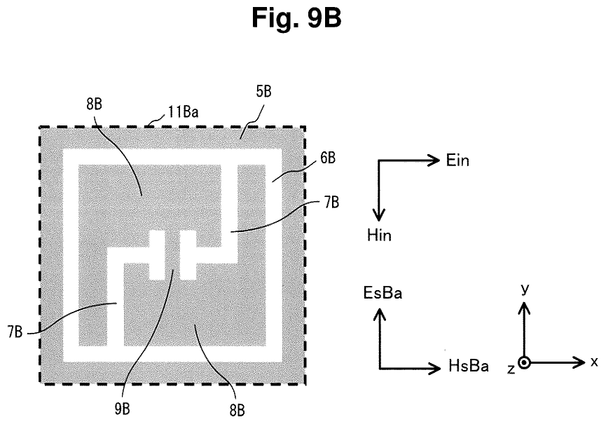

Similarly to the first and second embodiments, also in the present embodiment, it is possible to form a unit cell in which the bending direction of the conductor-removed region is reversed. A unit cell 11Ba illustrated in FIGS. 9A and 9B includes a metal conductor layer 5B formed on the substrate and having a rectangular shape in plan view. In the conductor layer 5B, an annular conductor-removed region 6B, a conductor-removed region 7B formed so as to connect two points of the conductor-removed region 6B and equally divide the conductor pattern in the conductor-removed region 6B into two, two conductor patterns 8B equally divided by the conductor-removed region 7B, and a conductor remaining portion 9B dividing the conductor-removed region 7B so as to connect two conductor patterns 8B are formed. In the present embodiment, the conductor-removed region 7B is bent in a crank shape in the plane of the conductor layer 5B. The conductor-removed region 7B has two bent portions bent at 90 degrees, but the conductor remaining portion 9B is disposed between two bent portions. In this way, the unit cell 11Ba has a shape in which the presence or absence of the conductor pattern of the unit cell 11B is inverted.

In the unit cells 11Aa and 11Ba, the conductor-removed regions 7A and 7B are bent in a crank shape, but the bending directions of the conductor-removed region 7A and the conductor-removed region 7B are opposite to each other. That is, the unit cell 11Aa and the unit cell 11Ba are in mirror reflection symmetry.

In FIGS. 9A and 9B, HsBa represents the direction of the magnetic field component of the scattered wave radiated from the unit cell 11Ba, and EsBa represents the direction of the electric field component of the scattered wave radiated from the unit cell 11Ba.

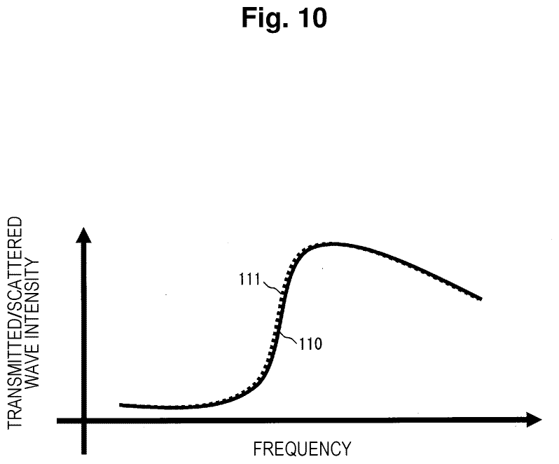

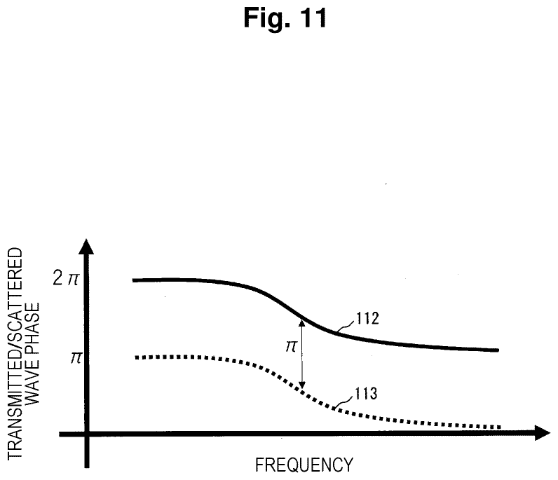

The phase of the scattered wave with respect to the phase of the incoming wave has a value different by π [rad] between the unit cell 11Aa and the unit cell 11Ba. FIG. 10 is a diagram illustrating the transmitted/scattered wave intensities of the unit cells 11Aa and 11Ba, and FIG. 11 is a diagram illustrating the transmitted/scattered wave phases of the unit cells 11Aa and 11Ba. Reference numerals 110 and 111 in FIG. 10 indicate the scattered wave intensities of the unit cells 11Aa and 11Ba, respectively. Reference numerals 112 and 113 in FIG. 11 indicate the scattered wave phases of the unit cells 11Aa and 11Ba, respectively.

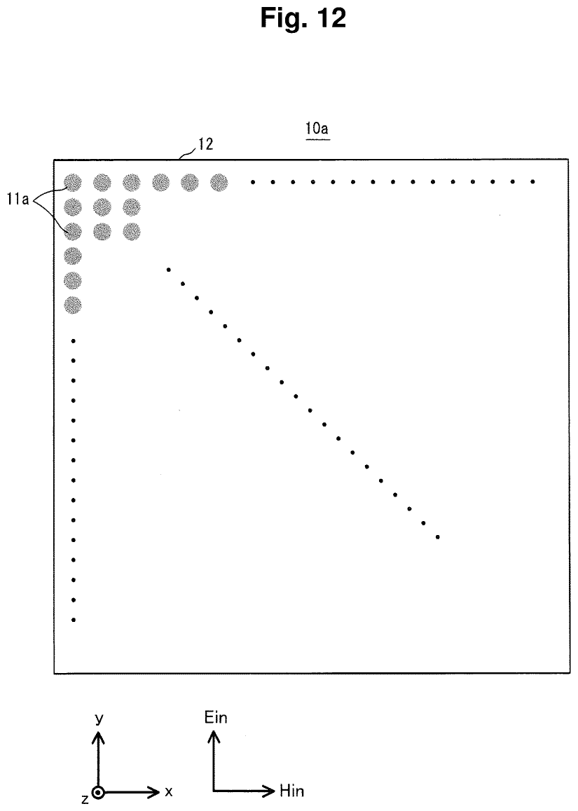

As described above, the relationship in which the phase of the transmitted/scattered wave is different by π [rad] between the unit cell 11Aa and the unit cell 11Ba is the same as those in the first and second embodiments. Therefore, similarly to the second embodiment, when the unit cell 11Aa is disposed at a position on the substrate 12 where the remainder obtained by dividing the phase difference Gₙ by 2π is in the range of zero to π, and the unit cell 11Ba is disposed at a position where the remainder is in the range of π to 2π, it is possible to realize the radio wave lens that functions in a wider band than that in the first and second embodiments in which the scattered wave in the transmission direction can be utilized only in the vicinity of the resonance frequency. FIG. 12 illustrates the structure of a radio wave lens 10a in which the unit cells 11Aa and 11Ba are two-dimensionally disposed on the substrate 12. Reference numeral 11a in FIG. 12 indicates the unit cell 11Aa or the unit cell 11Ba. Similarly to the second embodiment, a similar function can be realized even when the arrangement of the unit cell 11Aa and the arrangement of the unit cell 11Ba are switched.

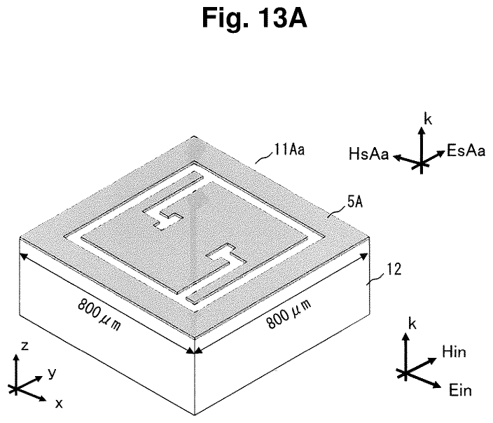

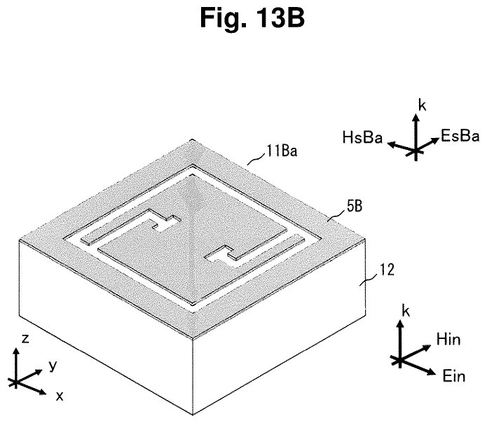

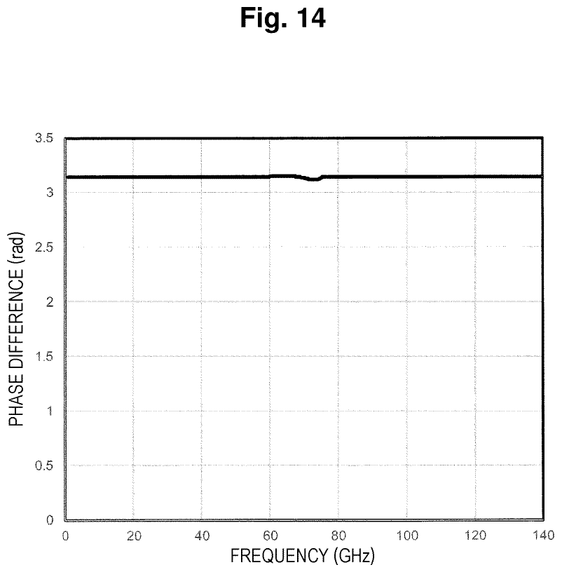

For example, FIG. 14 illustrates a result obtained by performing electromagnetic field analysis of the scattered wave phase difference in the structures of the unit cell 11Aa and the unit cell 11Ba in FIGS. 13A and 13B. In FIGS. 13A and 13B, k represents a wave number direction. The dimensions of the conductor layers 5A and 5B having rectangular shape in plan view in x and y directions are 800 μm. According to FIG. 14, it can be confirmed that the phase difference between the transmitted/scattered wave of the unit cell 11Aa and the transmitted/scattered wave of the unit cell 11Ba is π [rad] in the entire analysis frequency range.

### Fourth Embodiment

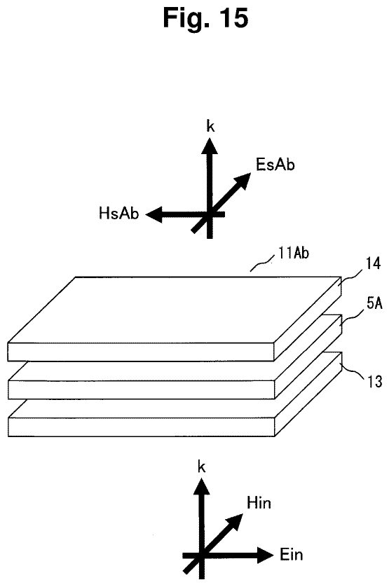

Next, a fourth embodiment of the present invention will be described. FIG. 15 is an exploded perspective view illustrating a structure of a unit cell according to the fourth embodiment of the present invention. In a unit cell 11Ab of the present embodiment, the polarizing layers 13 and 14 are disposed on the side of the conductor layer 5A described in the third embodiment on which the incoming wave is incident and the side of the conductor layer 5A from which the transmitted wave is emitted. In FIG. 15, HsAb represents the direction of the magnetic field component of the scattered wave radiated from the unit cell 11Ab, and EsAb represents the direction of the electric field component of the scattered wave radiated from the unit cell 11Ab.

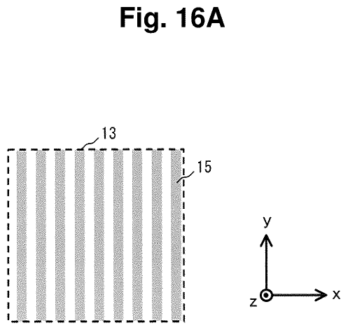

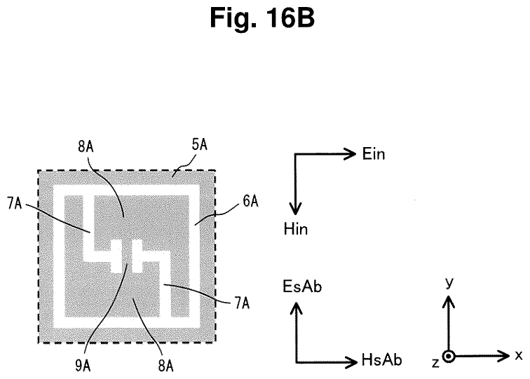

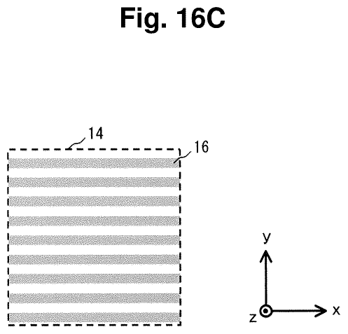

FIGS. 16A, 16B, and 16C are plan views illustrating structures of the polarizing layers 13 and 14 and the structure of the conductor layer 5A according to the present embodiment. The structure of the conductor layer 5A is as described in the third embodiment. In the polarizing layer 13 on the side where the incoming wave is incident on the conductor layer 5A, a metal conductor pattern 15 is formed such that polarized wave is transmitted in a direction (vertical direction in FIG. 16A, FIG. 16B, FIG. 16C) in which the conductor remaining portion 9A crosses the conductor-removed region 7A. On the other hand, in the polarizing layer 14 on the side where the transmitted wave is emitted from the conductor layer 5A, a metal conductor pattern 16 is formed such that the polarized wave is transmitted in a direction (horizontal direction in FIG. 16A, FIG. 16B, FIG. 16C) orthogonal to the direction in which the conductor remaining portion 9A crosses the conductor-removed region 7A. That is, the conductor pattern 16 is formed such that the polarizing layer 13 on the incident side and the transmitted polarization are rotated by 90 degrees.

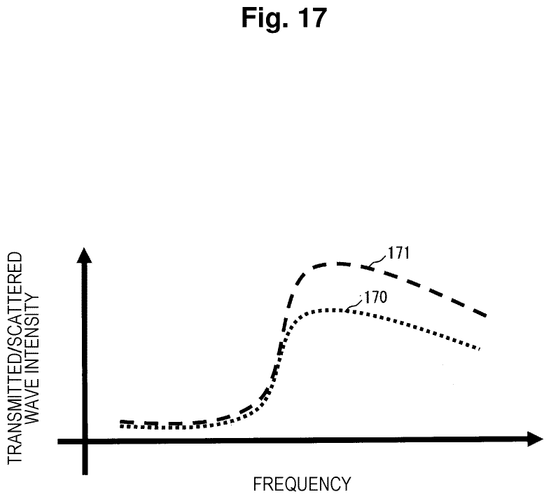

FIG. 17 illustrates the transmitted/scattered wave intensity of the unit cell 11Aa of the third embodiment and the transmitted/scattered wave intensity of the unit cell 11Ab of the present embodiment. Reference numerals 170 and 171 in FIG. 17 indicate the scattered wave intensities of the unit cells 11Aa and 11Ab, respectively. In the present embodiment, the transmitted/scattered wave intensity can be increased as compared with the third embodiment.

Note that both the polarizing layers 13 and 14 may be provided, or only one of the polarizing layers 13 and 14 may be provided.

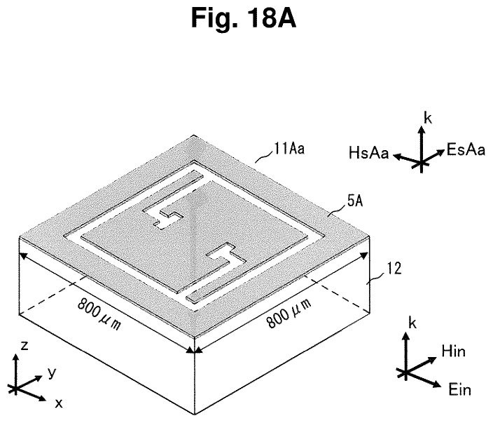

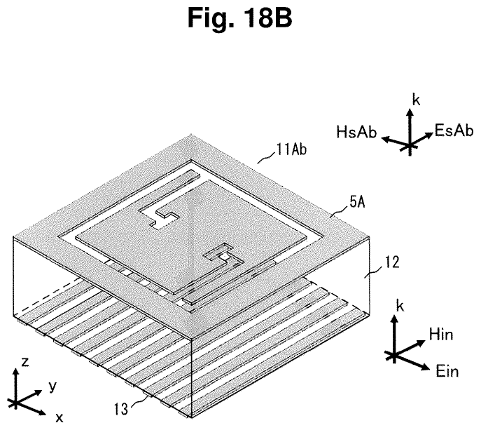

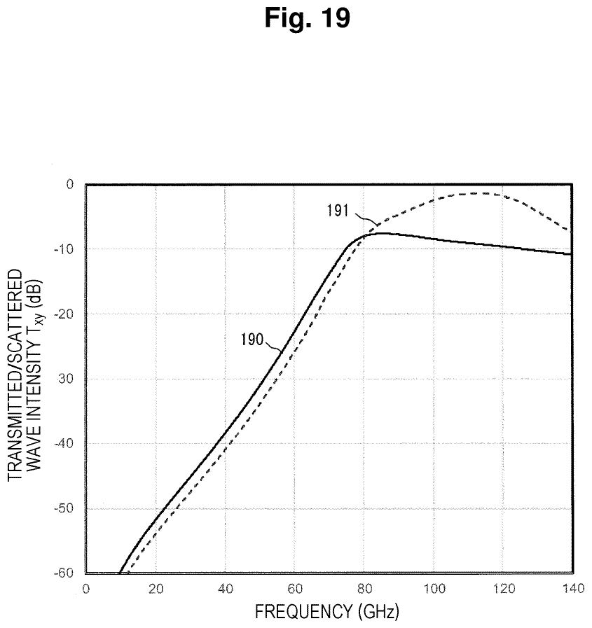

FIG. 19 illustrates a result obtained by performing the electromagnetic field analysis of the transmitted/scattered wave intensity for the unit cell 11Aa of the third embodiment illustrated in FIG. 18A and the unit cell 11Ab having an infinite periodic structure in which the conductor layer 5A is formed on one plane of the substrate 12 as illustrated in FIG. 18B and the polarizing layer 13 is formed on the other plane of the substrate 12. The dimensions of the conductor layers 5A of the unit cells 11Aa and 11Ab in x and y directions are 800 μm. In FIG. 19, reference numeral 190 denotes the transmitted/scattered wave intensity of the unit cell 11Aa, and reference numeral 191 denotes the transmitted/scattered wave intensity of the unit cell 11Ab. In the present embodiment, it can be seen that by providing the polarizing layer 13 on the side where the incoming wave is incident, the transmitted/scattered wave intensity is improved by 5 dB or more, the loss is 2 dB or less, and low-loss and broadband characteristics are obtained.

In the present embodiment, the case of using the conductor layer 5A of the unit cell 11Aa of the third embodiment has been described, but similarly, for the unit cell 11Ba, the polarizing layer can be disposed on at least one of the side where the incoming wave is incident or the side where the transmitted wave is emitted in the conductor layer 5B to form the unit cell.

In FIGS. 15, 16A, 16B, and 16C, when the unit cell in which the conductor layer 5B is disposed instead of the conductor layer 5A is set to 11Bb, the relationship in which the transmitted/scattered wave phase is different by π [rad] between the unit cell 11Ab and the unit cell 11Bb is the same as those in the first and second embodiments. Therefore, similarly to the second embodiment, when the unit cell 11Ab is disposed at a position on the substrate 12 where the remainder obtained by dividing the phase difference Gₙ by 2π is in the range of zero to π, and the unit cell 11Bb is disposed at a position where the remainder is in the range of π to 2π, it is possible to realize the radio wave lens that functions in a wider band than that in the first and second embodiments in which the scattered wave in the transmission direction can be utilized only in the vicinity of the resonance frequency. Similarly to the second embodiment, a similar function can be realized even when the arrangement of the unit cell 11Ab and the arrangement of the unit cell 11Bb are switched.

### Fifth Embodiment

In a case where the unit cell is disposed according to the second embodiment, when the distance D₁ from the wave source P₁ of the incoming wave to the reference point of the substrate 12 or the distance D₂ from the reference point to the reception point P₂ is shortened, the phase difference Gₙ of the radio wave caused by the optical path length difference between the unit cells greatly varies depending on the position of the unit cell on the substrate. Therefore, in a case where the distances D₁ and D₂ are short, it is desirable that the unit cell size is smaller.

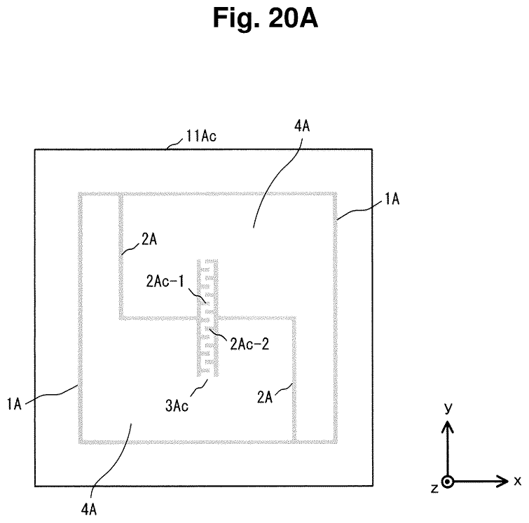

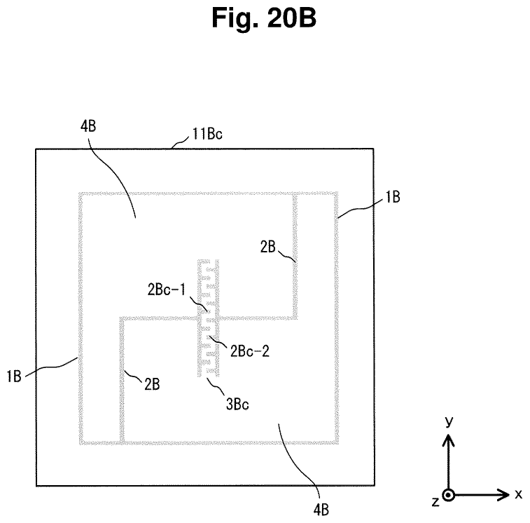

Therefore, as illustrated in FIGS. 20A and 20B, a unit cell size smaller for the wavelength at the use frequency can be realized by introducing a comb-teeth structure to a gap portion dividing the conductor portions 2A and 2B of the unit cell. In FIGS. 20A and 20B, the same components as those in FIGS. 2A and 2B are denoted by the same reference numerals.

A unit cell 11Ac includes an annular metal conductor portion 1A formed on a substrate, a metal conductor portion 2A formed on the substrate so as to connect two points of the conductor portion 1A and equally divide a region in the conductor portion 1A without a conductor pattern into two, and a gap 3Ac dividing the conductor portion 2A so as to connect two regions 4A equally divided by the conductor portion 2A. A conductor portion 2Ac-1 having a comb-teeth shape in plan view is formed at one end of the conductor portions 2A facing each other with the gap 3Ac interposed therebetween. At the other end of the conductor portions 2A facing each other with the gap 3Ac interposed therebetween, a conductor portion 2Ac-2 having a comb-teeth shape in plan view and disposed to face the conductor portion 2Ac-1 is formed so as to be alternately disposed with the conductor portion 2Ac-1.

A unit cell 11Bc includes an annular metal conductor portion 1B formed on a substrate, a metal conductor portion 2B formed on the substrate so as to connect two points of the conductor portion 1B and equally divide a region in the conductor portion 1B without the conductor pattern into two, and a gap 3Bc dividing the conductor portion 2B so as to connect two regions 4B equally divided by the conductor portion 2B. A conductor portion 2Bc-1 having a comb-teeth shape in plan view is formed at one end of the conductor portions 2B facing each other with the gap 3Bc interposed therebetween. At the other end of the conductor portions 2B facing each other with the gap 3Bc interposed therebetween, a conductor portion 2Bc-2 having a comb-teeth shape in plan view and disposed to face the conductor portion 2Bc-1 is formed so as to be alternately disposed with the conductor portion 2Bc-1.

In the unit cells 11Ac and 11Bc, the conductor portions 2A and 2B are bent in a crank shape, but the bending directions of the conductor portion 2A and the conductor portion 2B are opposite to each other. The unit cell 11Ac and the unit cell 11Bc are in mirror reflection symmetry.

In a case where the radio wave lens is configured using the unit cells 11Ac and 11Bc, similarly to the second embodiment, the unit cell 11Ac is only required to be disposed at a position on the substrate 12 where the remainder obtained by dividing the phase difference Gₙ by 2π is in the range of zero to π, and the unit cell 11Bc is only required to be disposed at a position where the remainder is in the range of a to 2π. A similar function can be realized even when the arrangement of the unit cell 11Ac and the arrangement of the unit cell 11Bc are switched.

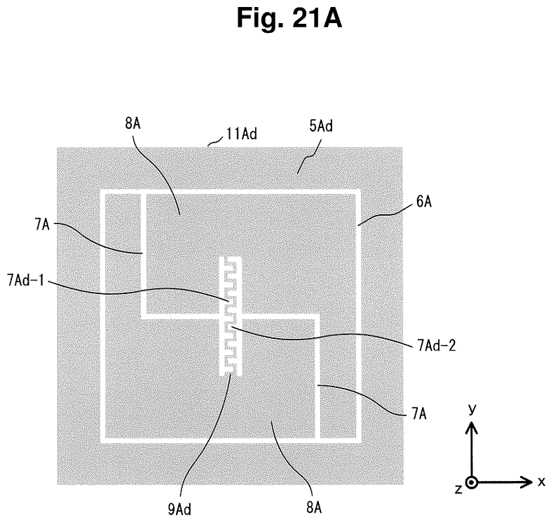

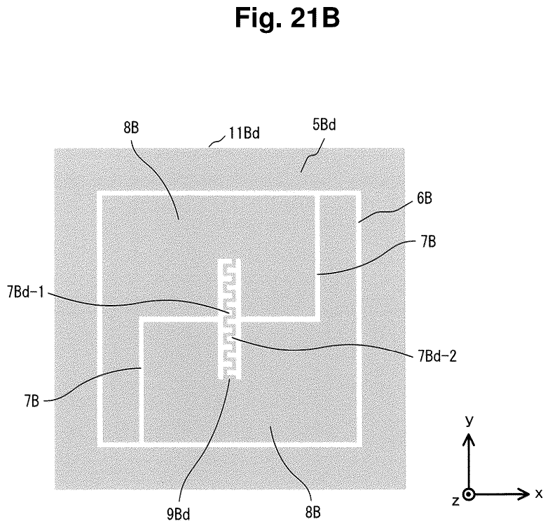

In the examples of FIGS. 20A and 20B, a case where the comb-teeth structure is applied to the first embodiment is described, but the comb-teeth structure may be applied to the third and fourth embodiments as illustrated in FIGS. 21A and 21B. In FIGS. 21A and 21B, the same components as those in FIGS. 9A and 9B are denoted by the same reference numerals.

A unit cell 11Ad includes a metal conductor layer 5Ad formed on the substrate and having a rectangular shape in plan view. In the conductor layer 5Ad, an annular conductor-removed region 6A, a conductor-removed region 7A formed so as to connect two points of the conductor-removed region 6A and equally divide the conductor pattern in the conductor-removed region 6A into two, two conductor patterns 8A equally divided by the conductor-removed region 7A, and a conductor remaining portion 9Ad dividing the conductor-removed region 7A so as to connect two conductor patterns 8A are formed. A conductor-removed region 7Ad-1 having a comb-teeth shape in plan view is formed at one end of the conductor-removed regions 7A facing each other with the conductor remaining portion 9Ad interposed therebetween. At the other end of the conductor-removed regions 7A facing each other with the conductor remaining portion 9Ad interposed therebetween, a conductor-removed region 7Ad-2 having a comb-teeth shape in plan view and disposed to face the conductor-removed region 7Ad-1 is formed so as to be alternately disposed with the conductor-removed region 7Ad-1. The unit cell 11Ad has a shape in which the presence or absence of the conductor pattern of the unit cell 11Ac is inverted.

A unit cell 11Bd includes a metal conductor layer 5Bd formed on the substrate and having a rectangular shape in plan view. In the conductor layer 5Bd, an annular conductor-removed region 6B, a conductor-removed region 7B formed so as to connect two points of the conductor-removed region 6B and equally divide the conductor pattern in the conductor-removed region 6B into two, two conductor patterns 8B equally divided by the conductor-removed region 7B, and a conductor remaining portion 9Bd dividing the conductor-removed region 7B so as to connect two conductor patterns 8B are formed. A conductor-removed region 7Bd-1 having a comb-teeth shape in plan view is formed at one end of the conductor-removed regions 7B facing each other with the conductor remaining portion 9Bd interposed therebetween. At the other end of the conductor-removed regions 7B facing each other with the conductor remaining portion 9Bd interposed therebetween, a conductor-removed region 7Bd-2 having a comb-teeth shape in plan view and disposed to face the conductor-removed region 7Bd-1 is formed so as to be alternately disposed with the conductor-removed region 7Bd-1. The unit cell 11Bd has a shape in which the presence or absence of the conductor pattern of the unit cell 11Bc is inverted.

In a case where the radio wave lens is configured using the unit cells 11Ad and 11Bd, similarly to the second embodiment, the unit cell 11Ad is only required to be disposed at a position on the substrate 12 where the remainder obtained by dividing the phase difference Gₙ by 2π is in the range of zero to π, and the unit cell 11Bd is only required to be disposed at a position where the remainder is in the range of π to 2π. A similar function can be realized even when the arrangement of the unit cell 11Ad and the arrangement of the unit cell 11Bd are switched.

As described in the fourth embodiment, the polarizing layer may be disposed on at least one of the side of the conductor layers 5Ad and 5Bd where the incoming wave is incident or the side where the transmitted wave is emitted.

In the present embodiment, since the size of the unit cell can be reduced, a reception point at which the radio wave is guided by the radio wave lens can be designed to have a short distance, or a deflection angle of the radio wave by the radio wave lens can be designed to have a large value.

### Sixth Embodiment

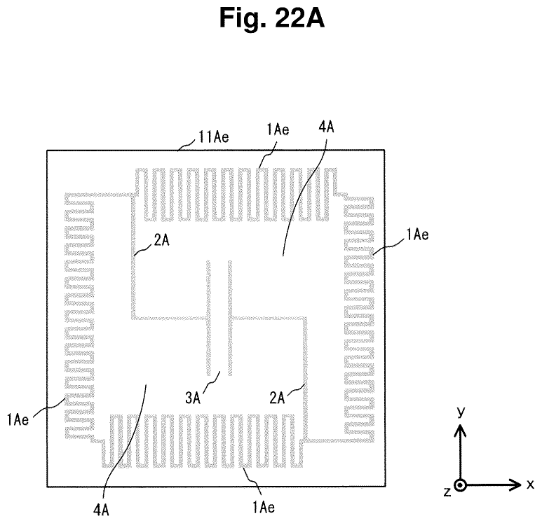

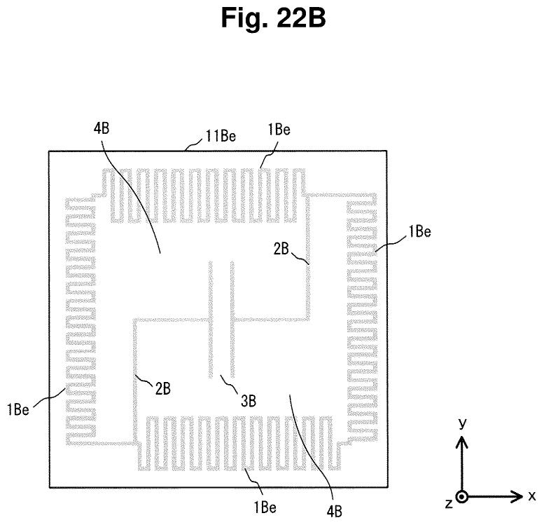

In the present embodiment, as illustrated in FIGS. 22A and 22B, a unit cell size smaller for the wavelength at the use frequency can be realized as in the fifth embodiment by introducing a meander line structure to an annular conductor portion of the unit cell. In FIGS. 22A and 22B, the same components as those in FIGS. 2A and 2B are denoted by the same reference numerals.

A unit cell 11Ae includes an annular metal conductor portion 1Ae formed on a substrate, a metal conductor portion 2A formed on the substrate so as to connect two points of the conductor portion 1Ae and equally divide a region in the conductor portion 1Ae without the conductor pattern into two, and a gap 3A dividing the conductor portion 2A. The conductor portion 1Ae is formed in a meander line shape.

A unit cell 11Be includes an annular metal conductor portion 1Be formed on a substrate, a metal conductor portion 2B formed on the substrate so as to connect two points of the conductor portion 1Be and equally divide a region in the conductor portion 1Be without the conductor pattern into two, and a gap 3B dividing the conductor portion 2B. The conductor portion 1Be is formed in a meander line shape.

In the unit cells 11Ae and 11Be, the conductor portions 2A and 2B are bent in a crank shape, but the bending directions of the conductor portion 2A and the conductor portion 2B are opposite to each other. The unit cell 11Ae and the unit cell 11Be are in mirror reflection symmetry.

In a case where the radio wave lens is configured using the unit cells 11Ae and 11Be, similarly to the second embodiment, the unit cell 11Ae is only required to be disposed at a position on the substrate 12 where the remainder obtained by dividing the phase difference Gₙ by 2π is in the range of zero to π, and the unit cell 11Be is only required to be disposed at a position where the remainder is in the range of π to 2π. A similar function can be realized even when the arrangement of the unit cell 11Ae and the arrangement of the unit cell 11Be are switched.

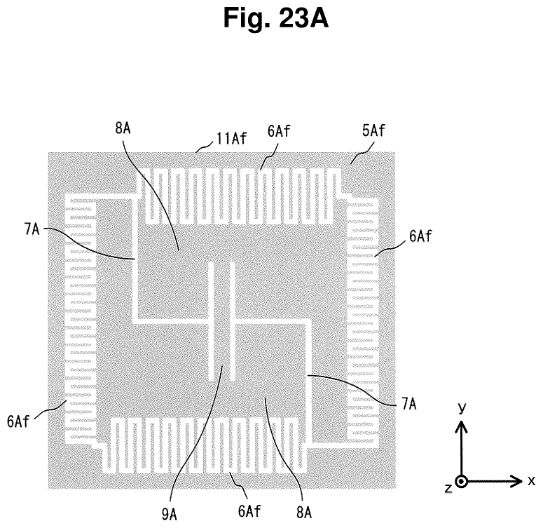

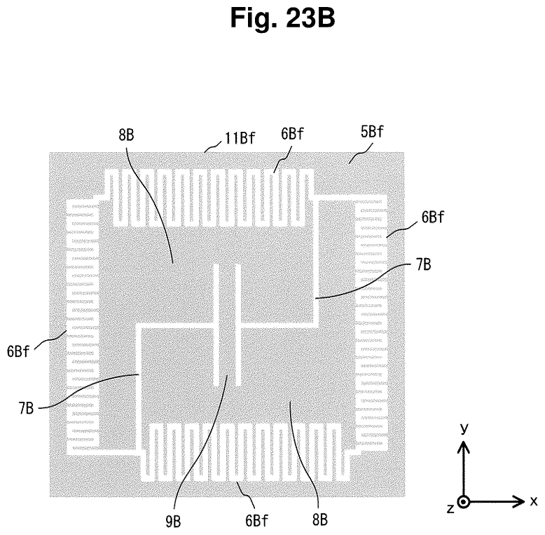

In the examples of FIGS. 22A and 22B, a case where the meander line structure is applied to the first embodiment is described, but the meander line structure may be applied to the third and fourth embodiments as illustrated in FIGS. 23A and 23B. In FIGS. 23A and 23B, the same components as those in FIGS. 9A and 9B are denoted by the same reference numerals.

A unit cell 11Af includes a metal conductor layer 5Af formed on the substrate and having a rectangular shape in plan view. In the conductor layer 5Af, an annular conductor-removed region 6Af, a conductor-removed region 7A formed so as to connect two points of the conductor-removed region 6Af and equally divide the conductor pattern in the conductor-removed region 6Af into two, two conductor patterns 8A equally divided by the conductor-removed region 7A, and a conductor remaining portion 9A dividing the conductor-removed region 7A are formed. The conductor-removed region 6Af is formed in a meander line shape. The unit cell 11Af has a shape in which the presence or absence of the conductor pattern of the unit cell 11Ae is inverted.

A unit cell 11Bf includes a metal conductor layer 5Bf formed on the substrate and having a rectangular shape in plan view. In the conductor layer 5Bf, an annular conductor-removed region 6Bf, a conductor-removed region 7B formed so as to connect two points of the conductor-removed region 6Bf and equally divide the conductor pattern in the conductor-removed region 6Bf into two, two conductor patterns 8B equally divided by the conductor-removed region 7B, and a conductor remaining portion 9B dividing the conductor-removed region 7B are formed. The conductor-removed region 6Bf is formed in a meander line shape. The unit cell 11Bf has a shape in which the presence or absence of the conductor pattern of the unit cell 11Be is inverted.

In a case where the radio wave lens is configured using the unit cells 11Af and 11Bf, similarly to the second embodiment, the unit cell 11Af is only required to be disposed at a position on the substrate 12 where the remainder obtained by dividing the phase difference Gₙ by 2π is in the range of zero to π, and the unit cell 11Bf is only required to be disposed at a position where the remainder is in the range of π to 2π. A similar function can be realized even when the arrangement of the unit cell 11Af and the arrangement of the unit cell 11Bf are switched.

As described in the fourth embodiment, the polarizing layer may be disposed on at least one of the side of the conductor layers 5Af and 5Bf where the incoming wave is incident or the side where the transmitted wave is emitted.

### Seventh Embodiment

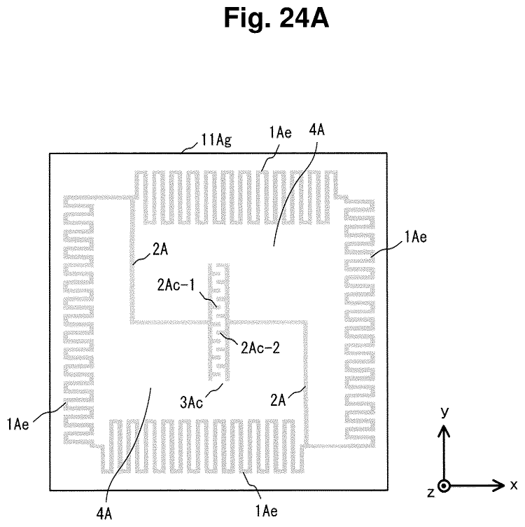

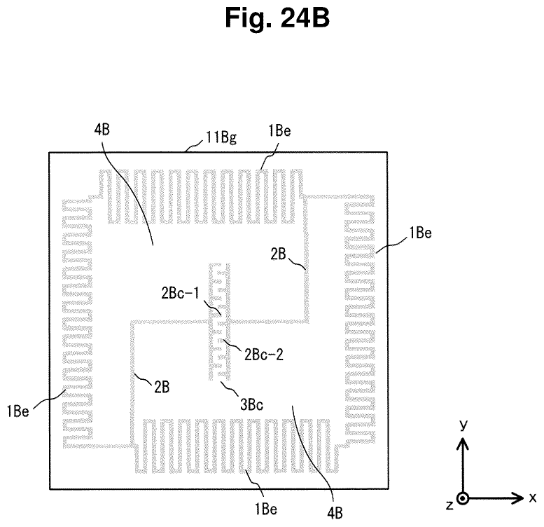

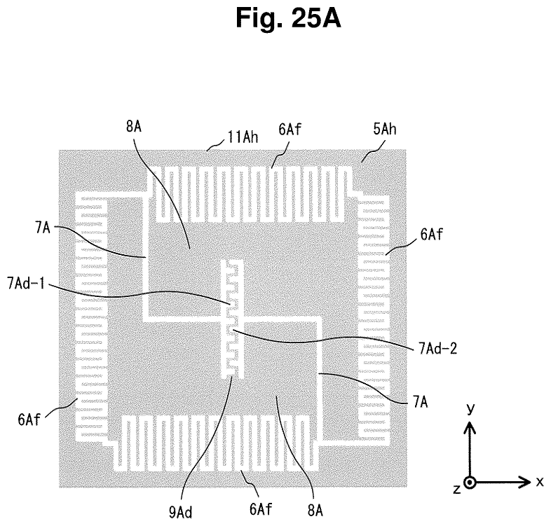

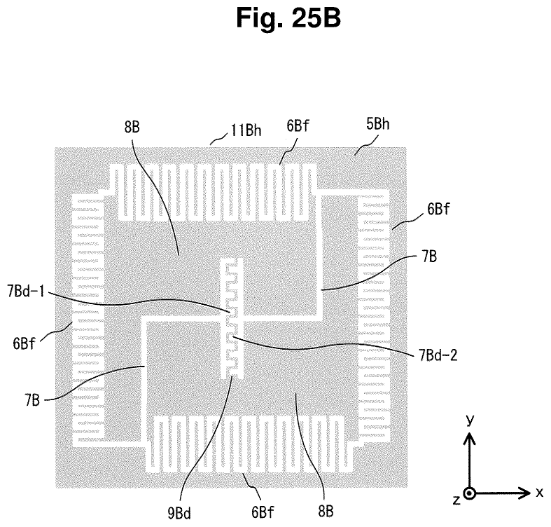

As illustrated in FIGS. 24A, 24B, 25A, and 25B, the fifth embodiment and the sixth embodiment can be combined. In FIGS. 24A and 24B, the same components as those in FIGS. 2A, 2B, 20A, 20B, 22A, and 22B are denoted by the same reference numerals. A unit cell 11Ag includes an annular metal conductor portion 1Ae formed on a substrate, a metal conductor portion 2A formed on the substrate so as to connect two points of the conductor portion 1Ae and equally divide a region in the conductor portion 1Ae without the conductor pattern into two, and a gap 3Ac dividing the conductor portion 2A. The conductor portions 2Ac-1 and 2Ac-2 having a comb-teeth shape in plan view are formed in the conductor portion 2A. The conductor portion 1Ae is formed in a meander line shape.

A unit cell 11Bg includes an annular metal conductor portion 1Be formed on a substrate, a metal conductor portion 2B formed on the substrate so as to connect two points of the conductor portion 1Be and equally divide a region in the conductor portion 1Be without the conductor pattern into two, and a gap 3Bc dividing the conductor portion 2B. The conductor portions 2Bc-1 and 2Bc-2 having a comb-teeth shape in plan view are formed in the conductor portion 2B. The conductor portion 1Be is formed in a meander line shape.

In a case where the radio wave lens is configured using the unit cells 11Ag and 11Bg, similarly to the second embodiment, the unit cell 11Ag is only required to be disposed at a position on the substrate 12 where the remainder obtained by dividing the phase difference Gₙ by 2π is in the range of zero to π, and the unit cell 11Bg is only required to be disposed at a position where the remainder is in the range of π to 2π. A similar function can be realized even when the arrangement of the unit cell 11Ag and the arrangement of the unit cell 11Bg are switched.

In FIGS. 25A and 25B, the same components as those in FIGS. 9A, 9B, 21A, 21B, 23A, and 23B are denoted by the same reference numerals. A unit cell 11Ah includes a metal conductor layer 5Ah formed on the substrate and having a rectangular shape in plan view. In the conductor layer 5Ah, an annular conductor-removed region 6Af, a conductor-removed region 7A formed so as to connect two points of the conductor-removed region 6Af and equally divide the conductor pattern in the conductor-removed region 6Af into two, two conductor patterns 8A equally divided by the conductor-removed region 7A, and a conductor remaining portion 9Ad dividing the conductor-removed region 7A so as to connect two conductor patterns 8A are formed. The conductor-removed regions 7Ad-1 and 7Ad-2 having a comb-teeth shape in plan view are formed in the conductor-removed region 7A. The conductor-removed region 6Af is formed in a meander line shape. The unit cell 11Ah has a shape in which the presence or absence of the conductor pattern of the unit cell 11Ag is inverted.

A unit cell 11Bh includes a metal conductor layer 5Bh formed on the substrate and having a rectangular shape in plan view. In the conductor layer 5Bh, an annular conductor-removed region 6Bf, a conductor-removed region 7B formed so as to connect two points of the conductor-removed region 6Bf and equally divide the conductor pattern in the conductor-removed region 6Bf into two, two conductor patterns 8B equally divided by the conductor-removed region 7B, and a conductor remaining portion 9Bd dividing the conductor-removed region 7B so as to connect two conductor patterns 8B are formed. The conductor-removed regions 7Bd-1 and 7Bd-2 having a comb-teeth shape in plan view are formed in the conductor-removed region 7B. The conductor-removed region 6Bf is formed in a meander line shape. The unit cell 11Bh has a shape in which the presence or absence of the conductor pattern of the unit cell 11Bg is inverted.

In a case where the radio wave lens is configured using the unit cells 11Ah and 11Bh, similarly to the second embodiment, the unit cell 11Ah is only required to be disposed at a position on the substrate 12 where the remainder obtained by dividing the phase difference Gₙ by 2π is in the range of zero to π, and the unit cell 11Bh is only required to be disposed at a position where the remainder is in the range of π to 2π. A similar function can be realized even when the arrangement of the unit cell 11Ah and the arrangement of the unit cell 11Bh are switched.

As described in the fourth embodiment, the polarizing layer may be disposed on at least one of the side of the conductor layers 5Ah and 5Bh where the incoming wave is incident or the side where the transmitted wave is emitted.

Some or all of the above-described embodiments may be described as the following supplementary notes, but are not limited to the following.

(Supplementary note 1) A radio wave lens of the present invention includes a first unit cell and a second unit cell that are two-dimensionally disposed on a plane of a substrate intersecting an incident radio wave, in which in each of the first unit cell and the second unit cell, a conductor portion bent in a crank shape in the plane of the substrate is formed or a conductor-removed region bent in the crank shape in the plane of the substrate is formed in a conductor layer on the substrate, bending directions of the conductor portions or the bending directions of the conductor-removed regions are different from each other, and the first unit cell and the second unit cell are two-dimensionally disposed according to a desired phase distribution of the radio wave transmitting through the first unit cell and the second unit cell.

(Supplementary note 2) In the radio wave lens according to Supplementary note 1, the first unit cell includes an annular first conductor portion formed on the substrate, a second conductor portion formed on the substrate so as to connect two points of the first conductor portion and equally divide a region in the first conductor portion without a conductor pattern into two, and a first gap dividing the second conductor portion so as to connect two regions equally divided by the second conductor portion, the second unit cell includes an annular third conductor portion formed on the substrate, a fourth conductor portion formed on the substrate so as to connect two points of the third conductor portion and equally divide a region in the third conductor portion without the conductor pattern into two, and a second gap dividing the fourth conductor portion so as to connect two regions equally divided by the fourth conductor portion, and the second conductor portion and the fourth conductor portion are bent in the crank shape in the plane of the substrate and the bending direction of the second conductor portion and the bending direction of the fourth conductor portion are different from each other.

(Supplementary note 3) In the radio wave lens according to Supplementary note 2, a fifth conductor portion having a comb-teeth shape is formed at one end of the second conductor portions facing each other with the first gap interposed therebetween, a sixth conductor portion having the comb-teeth shape and disposed to face the fifth conductor portion so as to be alternately disposed with the fifth conductor portion is formed at another end of the second conductor portions facing each other with the first gap interposed therebetween, a seventh conductor portion having the comb-teeth shape is formed at one end of the fourth conductor portions facing each other with the second gap interposed therebetween, and an eighth conductor portion having a comb-teeth shape and disposed to face the seventh conductor portion so as to be alternately disposed with the seventh conductor portion is formed at another end of the fourth conductor portions facing each other with the second gap interposed therebetween.

(Supplementary note 4) In the radio wave lens according to Supplementary note 2, each of the first conductor portion and the third conductor portion is formed in a meander line shape.

(Supplementary note 5) In the radio wave lens according to Supplementary note 1, the first unit cell includes a first conductor layer formed on the substrate, the second unit cell includes a second conductor layer formed on the substrate, in the first conductor layer, an annular first conductor-removed region, a second conductor-removed region formed so as to connect two points of the first conductor-removed region and equally divide a conductor pattern in the first conductor-removed region into two, and a first conductor remaining portion dividing the second conductor-removed region so as to connect two conductor patterns equally divided by the second conductor-removed region are formed, in the second conductor layer, an annular third conductor-removed region, a fourth conductor-removed region formed so as to connect two points of the third conductor-removed region and equally divide the conductor pattern in the third conductor-removed region into two, and a second conductor remaining portion dividing the fourth conductor-removed region so as to connect two conductor patterns equally divided by the fourth conductor-removed region are formed, and the second conductor-removed region and the fourth conductor-removed region are bent in a crank shape in the plane of the substrate, and have different bending directions.

(Supplementary note 6) In the radio wave lens according to Supplementary note 5, a fifth conductor-removed region having a comb-teeth shape is formed at one end of the second conductor-removed regions facing each other with the first conductor remaining portion interposed therebetween, a sixth conductor-removed region having the comb-teeth shape and disposed to face the fifth conductor-removed region so as to be alternately disposed with the fifth conductor-removed region is formed at another end of the second conductor-removed regions facing each other with the first conductor remaining portion interposed therebetween, a seventh conductor-removed region having the comb-teeth shape is formed at one end of the fourth conductor-removed regions facing each other with the second conductor remaining portion interposed therebetween, and an eighth conductor-removed region having the comb-teeth shape and disposed to face the seventh conductor-removed region so as to be alternately disposed with the seventh conductor-removed region is formed at another end of the fourth conductor-removed regions facing each other with the second conductor remaining portion interposed therebetween.

(Supplementary note 7) In the radio wave lens according to Supplementary note 5, each of the first conductor-removed region and the third conductor-removed region is formed in a meander line shape.

(Supplementary note 8) In the radio wave lens according to any one of Supplementary notes 5 to 7, each of the first unit cell and the second unit cell includes, on at least one of a side where a radio wave is incident or a side where the radio wave is emitted, a polarizing layer disposed in parallel with the first and second conductor layers and causing only a desired polarized wave to be transmitted.

### INDUSTRIAL APPLICABILITY

Embodiments of the present invention can be applied to a technology for controlling the transmission phase distribution of the radio wave.

### REFERENCE SIGNS LIST

1A, 1Ae, 1B, 1Be, 2A, 2Ac-1, 2Ac-2, 2B, 2Bc-1, 2Bc-2 Conductor portion
3A, 3B Gap
5A, 5Ad, 5Af, 5Ah, 5B, 5Bd, 5Bf, 5Bh Conductor layer
8A, 8B Conductor pattern
6A, 6Af, 6B, 6Bf, 7A, 7Ad-1, 7Ad-2, 7B, 7Bd-1, 7Bd-2 Conductor-removed region
9A, 9Ad, 9B Conductor remaining portion
10, 10a Radio wave lens
11A, 11Aa to 11Ah, 11B, 11Ba to 11Bh Unit cell
12 Substrate
13, 14 Polarizing layer
15, 16 Conductor pattern

1.-8. (canceled)

9. A radio wave lens comprising:
a plurality of first unit cells; and
a plurality of second unit cells, the plurality of first unit cells and the plurality of second unit cells are two-dimensionally disposed on a plane of a substrate, the plane of the substrate being configured to intersects an incident radio wave,
wherein each of the plurality of first unit cells includes a conductor portion bent in a crank shape in the plane of the substrate or a conductor-free region bent in the crank shape in the plane of the substrate and disposed in a conductor layer on the substrate, each of the plurality of second unit cells including a conductor portion bent in a crank shape in the plane of the substrate or a conductor-free region bent in the crank shape in the plane of the substrate and disposed in a conductor layer on the substrate,
wherein a bending direction of the conductor portion or a bending direction of the conductor-free region of each the plurality of first unit cells and a bending direction of the conductor portions or a bending direction of the conductor-free regions of the plurality of second unit cells are different between the plurality of first unit cells and the plurality of second unit cells, and
wherein the plurality of first unit cells and the plurality of second unit cells are two-dimensionally disposed according to a predetermined phase distribution of the incident radio wave transmitting through the plurality of first unit cells and the plurality of second unit cells.

10. The radio wave lens according to claim 9, wherein each of the plurality of first unit cells includes:
an annular first conductor portion on the substrate;
a second conductor portion on the substrate so as to connect two points of the annular first conductor portion and equally divide a region in the annular first conductor portion without a conductor pattern into two; and
a first gap dividing the second conductor portion so as to connect two regions equally divided by the second conductor portion.

11. The radio wave lens according to claim 10, wherein each of the plurality of second unit cells includes:
an annular third conductor portion on the substrate;
a fourth conductor portion on the substrate so as to connect two points of the annular third conductor portion and equally divide a region in the annular third conductor portion without the conductor pattern into two; and
a second gap dividing the fourth conductor portion so as to connect two regions equally divided by the fourth conductor portion,
wherein the second conductor portion and the fourth conductor portion are bent in the crank shape in the plane of the substrate, and a bending direction of the second conductor portion and a bending direction of the fourth conductor portion are different from each other.

12. The radio wave lens according to claim 11, wherein each of the plurality of first unit cells further includes:
a fifth conductor portion formed in a comb-teeth shape at a first end of the second conductor portions facing each other with the first gap interposed therebetween; and
a sixth conductor portion formed in a comb-teeth shape at a second end of the second conductor portions facing each other with the first gap interposed therebetween, and the sixth conductor portion faces the fifth conductor portion so as to be alternately disposed with the fifth conductor portion.

13. The radio wave lens according to claim 12, wherein each of the plurality of second unit cells further includes:
a seventh conductor portion formed in a comb-teeth shape at a first end of the fourth conductor portion facing the second gap; and
an eighth conductor portion formed in a comb-teeth shape at the a second end of the fourth conductor portion facing the second gap, and the eighth conductor portion faces the seventh conductor portion so as to be alternately disposed with the seventh conductor portion.

14. The radio wave lens according to claim 11, wherein:
the annular first conductor portion is in a meander line shape; and
the annular third conductor portion is in a meander line shape.

15. The radio wave lens according to claim 9, wherein each of the plurality of first unit cells includes:
a first conductor layer on the substrate, the first conductor layer including:
an annular first conductor-free region;
a second conductor-free region connecting two points of the annular first conductor-free region and equally divide a conductor pattern in the annular first conductor-free region into two; and
a first conductor remaining portion dividing the second conductor-free region so as to connect two conductor patterns equally divided by the second conductor-free region are formed.

16. The radio wave lens according to claim 15, wherein each of the plurality of second unit cells includes:
a second conductor layer on the substrate, the second conductor layer including:
an annular third conductor-free region;
a fourth conductor-free region connecting two points of the annular third conductor-free region and equally divide the conductor pattern in the annular third conductor-free region into two; and
a second conductor remaining portion dividing the fourth conductor-free region so as to connect two conductor patterns equally divided by the fourth conductor-free region are formed,
wherein the second conductor-free region and the fourth conductor-free region are bent in a crank shape in the plane of the substrate, and
wherein a bending direction of the second conductor remaining portion and a bending direction of the fourth conductor-free region are different from each other.

17. The radio wave lens according to claim 16, wherein
each of the plurality of first unit cells and the plurality of second unit cells includes, on at least one of a side where a radio wave is incident and a side where the radio wave is emitted, a polarizing layer disposed in parallel with the first and second conductor layers and causing only a desired polarized wave to be transmitted.

18. The radio wave lens according to claim 15, wherein the first conductor layer further includes:
a fifth conductor-free region formed in a comb-teeth shape at a first end of the second conductor-free region facing the first conductor remaining portion; and
a sixth conductor-free region formed in a comb-teeth shape at a second end of the second conductor-free region facing the first conductor remaining portion, and the sixth conductor-free region facing the fifth conductor-free region so as to be alternately disposed with the fifth conductor-free region.

19. The radio wave lens according to claim 17, wherein
each of the plurality of first unit cells and the plurality of second unit cells includes, on at least one of a side where a radio wave is incident and a side where the radio wave is emitted, a polarizing layer disposed in parallel with the first and second conductor layers and causing only a desired polarized wave to be transmitted.

20. The radio wave lens according to claim 17, wherein the second conductor layer further includes:
a seventh conductor-free region formed in a comb-teeth shape at a first end of the fourth conductor-free region facing the second conductor remaining portion; and
an eighth conductor-free region formed in a comb-teeth shape at a second end of the fourth conductor-free region facing the second conductor remaining portion, and the eighth conductor-free region facing the seventh conductor-free region so as to be alternately disposed with the seventh conductor-free region.

21. The radio wave lens according to claim 16, wherein
the annular first conductor-free region is formed in a meander line shape, and
the annular third conductor-free region is formed in a meander line shape.

22. The radio wave lens according to claim 19, wherein
each of the plurality of first unit cells and the plurality of second unit cells includes, on at least one of a side where a radio wave is incident and a side where the radio wave is emitted, a polarizing layer disposed in parallel with the first and second conductor layers and causing only a desired polarized wave to be transmitted.
